(19) United States
(12) Patent Application Publication
(10) Pub. No.: US 2008/0027886 A1
(43) Pub. Date: Jan. 31, 2008

(54) Data Mining Unlearnable Data Sets

(76) Inventors: Adam Kowalczyk, Glen Waverley (AU); Alex Smola, Cartin (AU); Cheng Soon Ong, Tuebingen (DE); Olivier Chapelle, Tubingen (DE)

Correspondence Address: SNELL & WILMER LLP (OC), 600 ANTON BOULEVARD, SUITE 1400, COSTA MESA, CA, 92626, US

(21) Appl. No.: 11/572,193

(22) PCT Filed: Jul. 18, 2005
(86) PCT No.: PCT/AU05/01037

§ 371 Date: Jan. 16, 2007

(30) Foreign Application Priority Data
Jul. 16, 2004 (AU) 2004903944

(51) Int. Cl. G06G 7/00

(52) U.S. Cl. 706/21

(57) ABSTRACT

This invention concerns data mining, that is the extraction of information, from “unlearnable” data sets. In particular it concerns apparatus and a method for this purpose. The invention involves creating a finite training sample from the data set (14). Then training (50) a learning device (32) using a supervised learning algorithm to predict labels for each item of the training sample. Then processing other data from the data set with the trained learning device to predict labels and determining whether the predicted labels are better (learnable) or worse (anti-learnable) than random guessing (52). And, using a reverser (34) to apply negative weighting to the predicted labels if it is worse (anti-learnable) (54).

### CROSS-REFERENCE TO RELATED APPLICATIONS

The present application claims priority from Provisional Patent Application No. 2004903944 filed on 16 Jul. 2004, the content of which is incorporated herein by reference.

### TECHNICAL FIELD

This invention concerns data mining, that is the extraction of information, from “unlearnable” data sets. In a first aspect it concerns apparatus for such data mining, and in a further aspect it concerns a method for such data mining.

### BACKGROUND ART

Learnable data sets are defined to be those from which information can be extracted using a conventional learning device such as support vector machines, decision trees, a regression, an artificial neural network, evolutionary algorithm, k-nearest neighbor or clustering methods.

To extract information from a data set, first a training sample is taken and a learning device is trained on the training sample using a supervised learning algorithm. Once trained the learning device, now called a predictor, can be used to process other samples of the data set, or the entire set.

Composite learning devices consist of several of the devices listed above together with a mixing stage that combines the outputs of the devices into a single output, for instance by a majority vote.

Data sets that cannot be successfully tined by such conventional means are termed “unlearnable”. The inventors have identified a class of “unlearnable” data which can be mined using a new technique, this class of data is termed “Anti-Learnable” data.

### DISCLOSURE OF THE INVENTION

The invention is apparatus for data mining unlearnable data sets, comprising:

a learning device trained using a supervised learning algorithm to predict labels for each item of a training sample; and,

a reverser to apply negative weighting to labels predicted for other data from the data set using the learning device, if necessary.

This apparatus is able to data mine a class of unlearnable data, the anti-learnable data sets.

The apparatus may further comprise:

a further learning device trained using a further supervised learning algorithm to predict labels for each item of a further training sample; and,

a reverser to apply negative weighting to labels predicted for other data from the data set using at least one learning device.

Where there is more than one learning device the training samples may be distinct from each other.

The apparatus may be embodied in a neural network, or other statistical machine learning algorithm.

At least one of the learning devices may use the k-nearest neighbour method or be a support vector machine, or other statistical machine learning algorithm.

The reverser may operate automatically. The reverser may be implemented as a direct majority voting method or developed from the data using a supervised machine learning technique such as a perceptron or a state vector machine (SVM).

In a further aspect the invention is a method for extracting information from unlearnable data sets, the method comprising the steps of:

creating a finite training sample from the data set;

training a learning device using a supervised learning algorithm to predict labels for each item of the training sample;

processing other data from the data set to predict labels and determining whether the other data is learnable (predicted labels are better than random guessing) or anti-learnable (predicted labels are worse than random guessing); and,

applying negative weighting to the predicted labels if the other data is anti-learnable.

The effect of this method is to identify whether data is learnable or anti-learnable. A learning index may be calculated to determine the learnability type, and the type may be output from the calculation.

The method may comprise the Her steps of:

training a further learning device using a further supervised learning algorithm to predict labels for each item of a limber training sample;

processing other data from the data set to predict labels and determining whether the predicted labels of the first and further learning devices are learnable or anti-learnable; and,

applying negative weighting to the predicted labels of a learning device if the data is anti-learnable.

The method may comprise the step of training a reverser to apply the negative weighting automatically.

The method may include the further step of transforming anti-learnable data into learnable data for conventional processing. The transformation may employ a non-monotonic kernel transformation. This transformation may increase within-class similarities and decrease between class similarities.

The method may comprise the additional step of using a learning device to idler process the weighted data.

The method may be enhanced by reducing the size of the training samples, or by selecting a “less informative” representation. (features) of the data, which increases the performance of the predictors below the level of random guessing. Mercer kernels may be used for this purpose.

The method may be embodied in software.

### BRIEF DESCRIPTION OF THE DRAWINGS

A number of examples of the invention will now be described with reference to the accompanying drawings, in which:

FIG. 1 is a block diagram of physical space and its data representation.

FIG. 2 is a block diagram showing the relationship between learning and anti-learning data sets.

FIG. 3 is a flow chart of a learnability detection test.

FIG. 4 is a block diagram of a sensor-reverser predictor.

FIG. 5 is a flow chart for the operation of a single sensor-reverser.

FIG. 6 is a diagram of XOR in 3-dimensions.

FIG. 7 is microarray data from biopsies.

FIG. 8(a) is a graph of testing and training results for squamaous-cell carcinomas, and FIG. 8(b) is a graph of testing and training results for adeno-carcinomas.

FIG. 9(a) is graph of testing results for real gene data, and FIG. 9(b) is a graph of testing results for a synthetic tissue growth model.

FIG. 10(a) is a graph of testing results for a high dimensional mimicry experiment with 1000 features, and FIG. 10(b) with 5000 features.

FIG. 11 is a diadgram showing the subsets of features removed for various values of a performance index.

FIG. 12 is a graph of training and testing results for data concerning microarray gene expression with features removed.

FIG. 13 is a graph of training and testing results for data concerning prognosis of breast cancer outcome.

FIGS. 14(a) and (b) are graphs of testing results for random 34% Hardamard data with different predictors.

### BEST MODES OF THE INVENTION

### Introduction

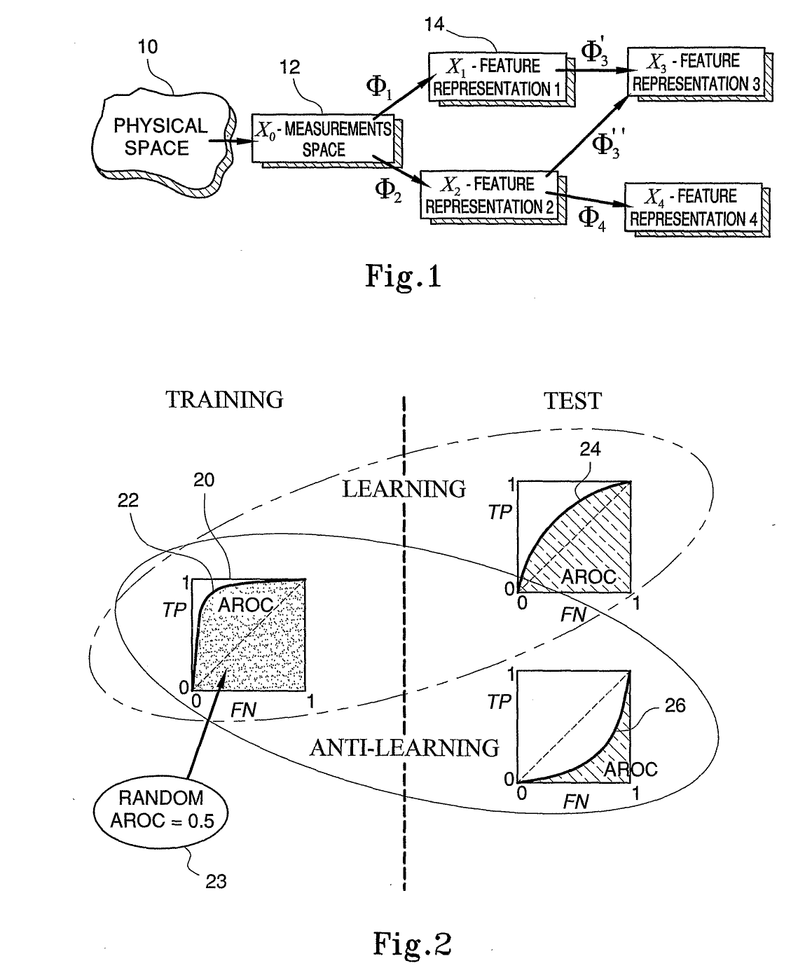

Referring to FIG. 1 there is a physical space 10 which might be the population of Canberra. We record data about this population to create a measurements space 12. We choose in this example to record the age, weight and height of each member of the population rounded to the nearest year, kilogram and centimeter, respectively. This measurement space is a finite subset of the physical space and can be represented as a 3-dimensional domain of patterns, X⊂R³. Each dimension of the domain represents a type of pattern, and each pattern is represented as a feature space 14.

We know that each member of the population will be either male or female. We can choose to apply a label Y to each item of the population data to indicate the sex. For instance Y may be +1 for a male or −1 for female. Y is a 1-dimensional space of labels. There is a probability that each member of the population will either be male or female, and a statistical probability distribution can be constructed for the population.

If we were to mine the data to apply the Y sex determining label to each member of the population, the steps would be as follows:

First a training sample of the data would be taken and a learning device trained on the training sample using a supervised leaning algorithm. Typically one type of pattern, or put another way one feature space, is selected for training. Once trained the learning device should model the dependence of labels on patterns in the form of a deterministic relation, a ƒ:X→R, where for each member of the training sample there is a probability of 1 that they are either male or female. The function f is a predictor and the trained learning device is now called a “predictor”.

FIG. 2 shows a graph 20 of a performance measure for a “predictor”. The measure is the Area under Receiver Operating Characteristic, AROC, or AUC, defined as the area under the plot of the true vs. false positive rate. Where there is a deterministic relation the predictor should have an AROC that is flat along the top, and the result shown at 22 is close to this perfect result. The result that would be obtained by a predictor randomly allocating labels is shown at 23 and represents a probability of 0.5.

The trained leaning device can now be used to process other samples of the data set or the entire set. When this is done, if the data set is a learning data set we expect to see a result similar to the plot show at 24. This is less perfect than the training result because the predictor does not operate perfectly.

When the data set is anti-learnable the result is less than random as shown in plot 26. Anti-learning is therefore a property a dataset exhibits when mined with a learning device trained in a particular way.

Anti-learning manifests itself in both natural and synthetic date. It is present in some practically important cases of machine learning from very low training sample sizes.

### Performance Metrics

We have mentioned already AROC as a metric measuring performance of a predictor. However other metrics are applicable here as well. For a purpose of an illustration we shall introduce the accuracy.

The AROC can be computed via an evaluation of conditional probabilities [Bamber, 1975]:

$$AROC [ f , {Z}^{′} ] = {P}_{{Z}^{′}} \{ f ( x ) < f ( {x}^{′} ) \vert y < {y}^{′} \} + \frac{1}{2} {P}_{{Z}^{′}} \{ f ( x ) = f ( {x}^{′} ) \vert y \neq {y}^{′} \}$$

Here we assume that z=(x,y)εZ′ and z′=(x′,y′)εZ′ are drawn from test distribution P_{z′}, i.e. the frequency count measure on a finite test set Z′⊂D. Clearly AROC[ƒ,Z′]=1 indicates perfect classification by the rule x|→ƒ(x)+b for a suitable threshold bεR; and the expectation AROC for a classifier randomly allocating the labels is 0.5.

Another measure is the accuracy, which is a class-calibrated version of a complement of the test error, ignoring skewed conditional class probabilities. We define it as

$$ACC [ f , {Z}^{′} ] \frac{1}{2} {\sum }_{{y}^{′} = \pm 1} {P}_{{Z}^{′}} \{ y f ( x ) > 0 \vert y \neq {y}^{′} \} ,$$

where we assume that z=(x,y)εZ′ are drawn from test distribution P_{z′}. The expected value for a random classifier is ACC[ƒ,Z′]=½ and perfect classification corresponds to ACC[ƒ,Z′]=1.

### Extracting Information From Unlearnable Data Sets

There are a number of steps in extracting information from unlearnable data sets, some of which may not always be required. The following description will address both essential and nonessential steps in the order in which they occur.

### Pattern Selection

In a typical data ruining task the selection of the suitable domain of patterns X is part of the data mining task. Referring again to FIG. 1 feature mappings, Φ₁, . . . , Φ₄, are used to map the measurements space 12 into the feature spaces, such as 14. The feature spaces contain patterns X₁, . . . , X₄ which are assumed to be a Hilbert space, a finite or infinite dimensional vector space equipped with a scalar product denoted <.|.>. In practice feature mappings are not used explicitly, but rather conceptually. Instead, Mercer kernels are used, which are relatively easy to handle numerically and are equivalent representations of a wide class of such mappings.

### Supervised Learning

The goal of supervised learning is to select a predictor ƒ:X₀→R mapping the measurement space 12 into real number. Such a selection is done on a basis of a finite training sample Z=((x₁,y₁), . . . ,(xₘ,yₘ))εD⊂R×{±1} of examples with known labels. This is achieved using a supervised learning algorithm, Alg, in a training process. The training outputs a function ƒ=Alg(Z,param) which as a rule predicts labels of the training data set better ten random guessing μ(ƒ,Z)>0.5, typically almost perfectly μ(ƒ,Z)≈1.0, where με{AROC, ACC} is a pre-selected performance measure.

The desire is to achieve a good prediction of labels on an independent test set Z′⊂D\Z not seen in training.

We say that the predictor f is learning (L-predictor) with respect to training on Z and testing on Z′ if μ(ƒ,Z)>0.5 and μ(ƒ,Z′)>0.5.

We say that the predictor f is anti-learning (AL-predictor) with respect to the training-testing pair (Z,Z′) if μ(ƒ,Z)>0.5 and μ(ƒ,Z′)<0.5.

We say that data set D is learnable (L-dataset) by algorithm Alg(.,param) if ƒ=Alg(Z,param) is an L-predictor for every training test pair (Z,Z′) Z⊂D and Z′⊂D\Z, after exclusion of obvious pathological cases. Analogously we define the anti-learnable data set, AL-data set.

Taking into consideration various feature representations Φ: X₀→Xⱼ these concepts are extended to the kernel case. It is assumed that the predictor ƒ=Alg(Z,k,param) depends also on a kernel k, and has the following data expansion form:

$$f ( x ) = {\sum }_{i = 1}^{m} {y}_{i} {α}_{i} k ( {x}_{i} , x ) + b$$

for xεX₀, where αᵢ,bεR are learnable parameters. For a range of popular algorithms such as support vector machines we have an additional assumption that αᵢ≧0 for all i and we write ƒεCONE(k,Z) in such a case. We say that the k is an AL-kernel on D, if the k-kernel machine f defined as above is an AL-predictor for every training set Z⊂D . Analogously, we define the L-kernel on D. Equivalently we can talk about learnable (L-) and anti-learnable (AL-) feature representations, respectively.

Note that equivalently these concepts can be introduced by considering the feature space representation Φ(X₀)⊂Xⱼ and the class of kernel machines with the linear kernel on Xⱼ.

### Recognition of Anti-Learning

Determination of whether data is of learning or anti-learning type is done empirically most of the time, depending on the learning algorithm and selection of learning parameters. However, in some cases the link can be made directly to the kernel matrix [Kᵢⱼ]. An example here is the cases of perfect anti-learning and the mirror concept of perfect learning, that is μ(ƒ,Z)=1 in training and μ(ƒ,Z′)=0 in an independent test and the μ(ƒ,Z)=μ(ƒ,Z′)=1 in both the training and an independent test, respectively, for every ƒεCONE(k,Z) and Z′⊂D\Z.

The following theorum is presented to assist in the determination:

Theorem 1 The following conditions for the Perfect Antilearning (PAL) are equivalent:
1. For every i there exists a constant bᵢεR such that yᵢyⱼKᵢⱼ<yᵢyⱼbⱼ for all j≠i.
2. For all i≠j, 1 with yᵢ=yⱼ≠yⱼ we have Kᵢⱼ<Kᵢⱼ.
3. For all fεCONE[k, Z] there exists some bεR such that yᵢ(f(xᵢ)−b)<0 for all (xᵢ,yᵢ)εZ/Z.

Moreover, the following conditions for Perfect Learning (PL) are equivalent
1. For every i there exists a constant bᵢ R such that yᵢyⱼKᵢⱼ>yᵢyⱼbⱼ for all j≠i.
2. For all i≠j, 1 with yᵢ=yⱼ≠yⱼ we have Kᵢⱼ>Kᵢⱼ.
3 For all fεCONE[k,Z] there exists some bεR such that yᵢ(f(xᵢ)−b)>0 for all (xᵢ,yᵢ)εZ/Z.

Corollary 3 PAL or PL, respectively, is equivalent to any of the following two conditions holding for V=0 or V=1, respectively, for every fεCONE[k, Z]:

1. AROC [f.Z′]=V for every Z′⊂Z\Z containing examples of both classes.

2. There exists some bεR such that Acc [f+b,Z′]=V for every Z′⊂Z

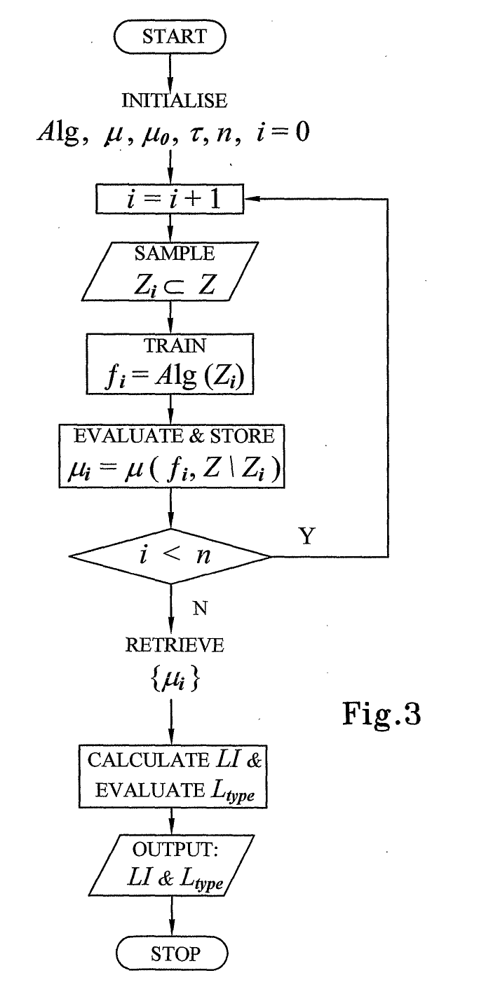

The following algorithm is illustrated in FIG. 3 and is used to detect the learnability type:

Given:

A supervised learning algorithm Alg,
a dataset Z,
a performance measure μ with its expected value μ₀ for the random guessing,
a training fraction τ, 0<τ<1,
a number n of x-validation tests and
a significance level ε>0.
   Generate:

For l=1:n repeat steps 1-3:
1. Sample a training subset Zᵢ⊂Z subset of size τ;
2. Create a predictor: ƒ₁=Alg(Z₁);
3. Evaluate its performance on the off-training data: μ₁=μ(ƒᵢ, Z\Zᵢ);

Output: the learning index

$$LI = LI ( A 1 g , Z ) := \frac{mean ( {μ}_{i} ) - {μ}_{0}}{std ( {μ}_{i} )} = \frac{{\sum }_{i = 1}^{n} {μ}_{i} / n - {μ}_{0}}{\sqrt{{\sum }_{i = 1}^{n} {μ}_{i}^{2} / n - {( {\sum }_{i = 1}^{n} {μ}_{i} / n )}^{2}}}$$

and the data/algorithm learnability type

$${L}_{type} ( Z , A 1 g ) = \{ \begin{matrix}L & if LI > 0 , \\ AL & if LI \leq 0 , \\ nonL & □ otherwise\end{matrix}$$

The learning index defined above shows how significantly the prediction of the algorithm deviates from the random guessing.

### Handling Anti-Learning Data

### Predictor with Reverser Classifiers

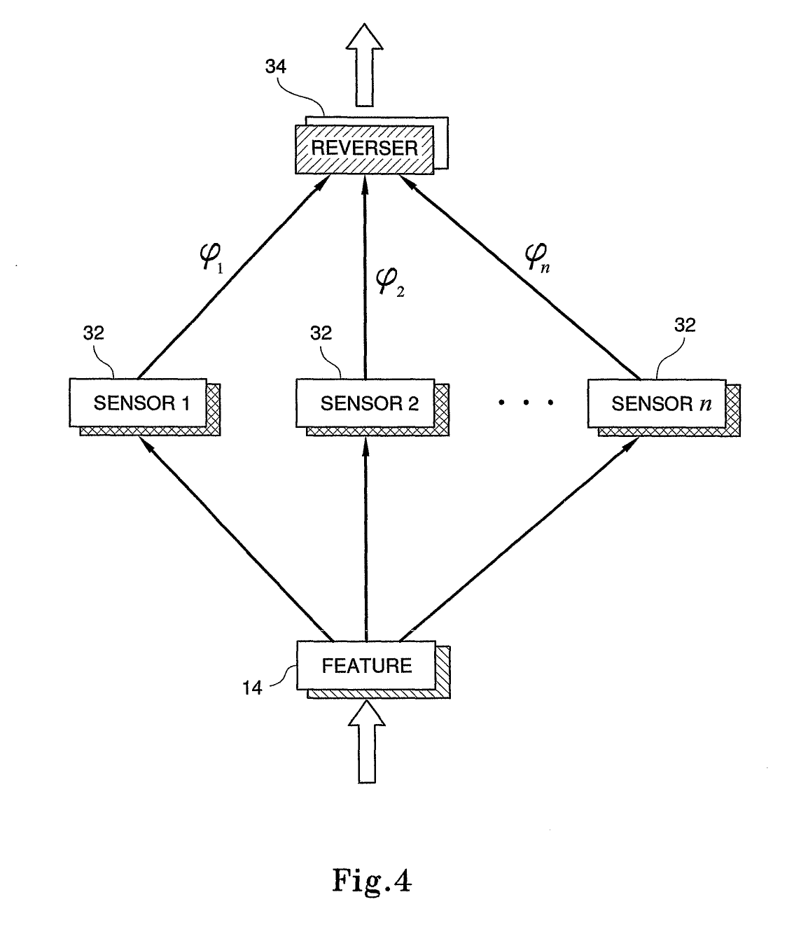

FIG. 4 is a two stage predictor with reverser classifier. Training generates one or more predictors 32 using a fraction of the training set. For each predictor we determine whether it is an L-predictor or an AL-predictor, using a selected metric and a pre-selected testing method. Examples of training methods include the leave-one-out cross validation, or validation on the fraction of the training set not used for the generation of thee sensor.

The outputs of all the predictors 32 are received at the reverser 34. If a predictor is AL, then its output will be negatively weighted by reverser 34 in the process of the final decision making. This is a different process to the classical algorithms using ensemble methods, such as boosting or bagging.

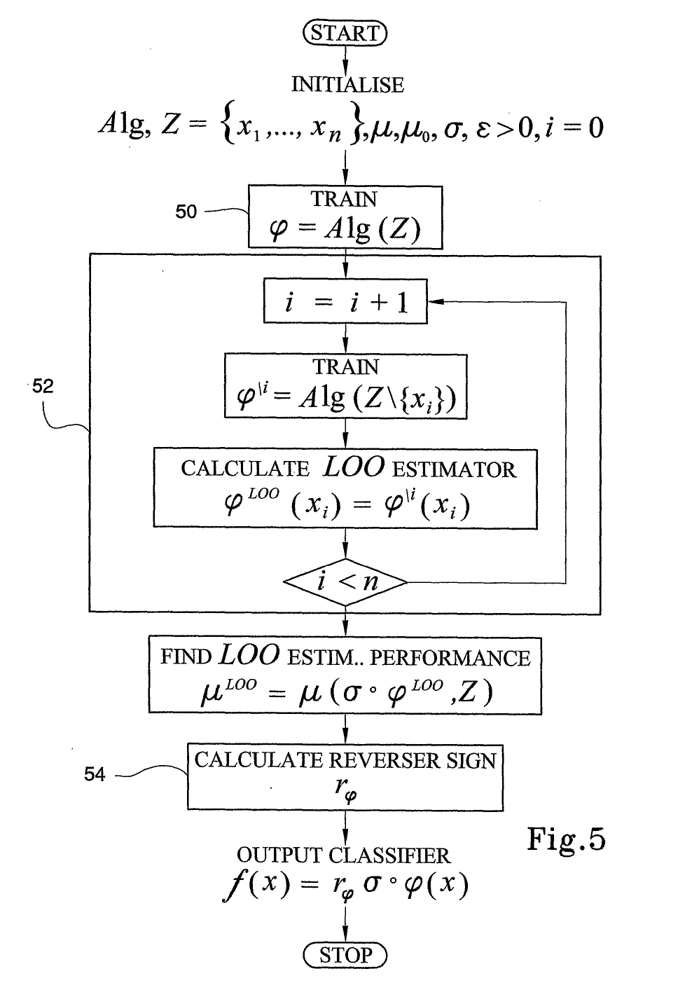

The following Single Sensor-Reverser Algorithm is used when there is a single predictor 32, and is illustrated in FIG. 5.

Given:

A supervised learning algorithm Alg,
a train set Z={x₁, . . . , xₙ},
a performance measure μ with its expected value μ₀ for the random guessing,
a squashing faction σ:R→R and
a significance level ε>0.

Generate:
1. Train a sensor predictor: φ=Alg(Z), 50.
2. Estimate performance of the sensor, μ^{LOO}=μ(σoφ^{LOO}, Z) using LOO-cross validation, i.e. φ^{LOO}(x):=φ^{\x}(x), where φ^{\z}:=Alg(Z\{x}) for every xεZ, 52.
3. Set the reverser weight:

$${r}_{φ} = sgn ( {μ}^{LOO} - {μ}_{0} ) {1}_{\vert {μ}_{φ} - {μ}_{0} \vert \geq ɛ} = \{ \begin{matrix}sgn ( {μ}^{LOO} - {μ}_{0} ) & if \vert {μ}^{LOO} - {μ}_{0} \vert \geq ɛ , \\ 0 & otherwise .\end{matrix}$$

Output: the predictor ƒ(x):=r_{φ}σoφ(x) for every x, 54.
Remark:
The leave-one-out test can be replaced by a validation of an independent validation set.

The main limitation of this algorithm is that it misclassifies the training set if data is anti-learnable, i.e. gives μ=μ(ƒ,Z)≦μ₀. The following algorithms are designed to overcome this limitation.

The following Multi-Sensor with Sign Reverser algorithm is used when there are more than one predictors.

Given:

A set of supervised learning algorithms for sensor training S_{Alg}.,
a training set Z,
a set τ_{sensTr} of fractions of the training set to be used for sensor training, number between 0 and 1;
a number of sensors nₛₑₙₛ,
a squashing function σ:R→R and
a significance level ε>0.
   Generate:

For i=1:nₛₑₙₛ repeat steps 1-4:
1. Select an algorithm AlgᵢεS_{Alg} a training fraction τᵢ ε frac_{sensTr} and then sample the sensor training subset Z\Zᵢ of size τ₁,
2. Create a sensor predictor: φ₁=Alg(Zᵢ);
3. Evaluate sensor performance μᵢ=μ(σoφ₁, Z\Zᵢ);
4. Set the reverser weight:

$${r}_{i} = \{ \begin{matrix}sgn ( {μ}_{i} - {μ}_{0} ) & if \vert {μ}_{i} - {μ}_{0} \vert \geq ɛ \\ 0 & otherwise .\end{matrix}$$

Output: the predictor

$$f ( x ) := {\sum }_{i = 1}^{{n}_{HHJ}} {r}_{i} σ \cdot {φ}_{i} ( x )$$

for every x.
Remarks:
In the case of AL-dataset it is recommended that fractions ia the set frac_{sensTr} are lower than 0.5, and preferably lower than 0.33.
There is a number of practical choices for the squashing function σ:R→R. Among those options are the identity, σ(ξ):=ξ, the signum, σ(ξ):=sgn(ξ), the sigmoid, σ(ξ):ξ1/(1+e^{-ξ}) and the ±1-clipping, σ(ξ):=max(−1, min(+1,ξ)), for all ξεR.
   The following algorithm not only trains the operation of the predictors but also of the reverser.
   Given:
A set of supervised learning algorithms for sensor training Algₛₑₙₛ;
an algorithm for reverser training Algᵣₑᵥᵣₛₑᵣ;
a sensor training set Z′;
a reverser training set Z″=(xᵢ,yᵢ)_{1≦1≦m″};
a subset frac_{sensTr} of fractions of the training set to be used for sensor training;
a number of sensors nₛₑₙₛ;
a squashing function σ:R→R and
a significance level ε>0.
   Generate:

For i1:nₛₑₙₛ create sensors by repeating steps 1-2:
1. Select au algorithm Algᵢ ε Algₛₑₙₛ, a training faction τ₁ εfrac_{sensTr} and then create a sensor training dataset Z₁, a random sample of size τ₁ of the dataset Z;
2. Create a sensor predictor: φ₁=Alg(Z₁); Train the reverser ρ=Algᵣₑᵥₑᵣₛₑᵣ (U), ρ:Rⁿ_{^{ocyte}}→R on the dataset
   U=((φ₁(x₁), . . . , φₙ_{ₛₑₙₛ}(x₁)), yᵢ)_{1≦1≦m}⊂Rⁿ_{^{sens±×{±1},}}
composed of the outputs of the sensors on Z″. Output: the predictor η(x):=ρo (φ₁(x), . . . , φₙ_{ₛₑₙₛ} (x)) for every x.
   Remark:
In the case of a limited size AL-dataset it advantageous to use the whole dataset for training. In such a case it makes sense to use the same data set for the sensor and reverser training, i.e. to set Z′=Z″=Z, and also to use the set of training fractions in frac_{sensTr} as small as practical, in particular≦0.33.
   Transformations of AL-Data into L-Data
   The following algorithm will transform some classes of AL-data into L-data using a non-monotonic kernel transformation.
   Given:
An AL-kernel matrix [Kᵢⱼ]_{1≦1,j≦m} for a Mercer kernel k on dataset Z=(x₁, y₁)_{1≦1≦m}.
A non-monotonic function φ:R→R such that
   0<φ(−θ)≦φ(θ)≦φ(θ′) for 0<θ≦θ′.
   Generate:
A transformed kernel matrix [Kᵢⱼ^{φ}]:=[φ(Kᵢⱼ−C)]_{1<1,j≦m}, where

$$C := {mean}_{{y}_{i} + {y}_{j}} \frac{{K}_{lj}}{\sqrt{{K}_{li} {K}_{jj}}} ;$$
An incomplete Choleski factorization of [Kᵢⱼ^{φ}], i.e. an m′×m matrix M=[Mᵢⱼ] such that [Kᵢⱼ^{φ}]=M^{T} M (if it exists);
   Output:
A transformed kernel matrix [Kᵢⱼ^{φ}] and
the corresponding feature map given by columns of the matrix M=[Mᵢⱼ], Φ(xⱼ):=[Mᵢⱼ]εR^{m′}, for 1≦j≦m.
   Remarks:
An example of function φ satisfying the above assumption is the ordinary power function φ(ξ):=ξ^{d} of even degree, d=2,4,6, . . .
However, this transformation does not always exists, since matrix [Kᵢⱼ^{φ}] could become indefinite.
   The following algorithm will transform some classes of AL-data into L-data using monotonic kernel transformation.
   Given:
An AL-kernel matrix [Kᵢⱼ]_{1≦1,j≦m} for a Mercer kernel k on a dataset Z=(x₁,y₁)_{1≦1≦m}.
   Generate:

A transformed kernel matrix [Kᵢⱼ^{λ}]:=[λδᵢⱼ−Kᵢⱼ]_{1≦1,j≦m}, where λ is the maximal eigenvalue of the symmetric matrix [Kᵢⱼ]_{1≦1,j≦m} and δᵢⱼ is the Kronecker delta symbol;
An incomplete Choleski factorization of the positive definite symmetric matrix [Kᵢⱼ^{λ}], i.e. an m′×m matrix M=[Mᵢⱼ] such that [Kᵢⱼ^{λ}]=M^{T} M (always exists in this case);
   Output:
A transformed kernel matrix [Kᵢⱼ^{λ}] and
the corresponding feature map determined by columns of the matrix M=[Mᵢⱼ], Φ(xⱼ):=[Mᵢⱼ]εR^{m′}, for 1≦j≦m.
   Remarks
This transformation always exists, since [Kᵢⱼ^{λ}] is always positive semidefinite.
It is guaranteed to transform any Perfect Anti-Learning feature space representation of a finite data set into a Perfect Learning feature space representation.
This transformation has limited capacity if used for prediction especially on data which are not perfect anti-learnable.

To understand the use of Mercer kernels in more detail, for simplicity let us consider a feature mapping Φ₁:X₀→X₁. The Mercer kernel for this mapping is a symmetric function k₁:X₀×X₀→R such that k₁(x,x′)=<Φ₁(x)|Φ₁(x′)> for every x,x′εX₀ and the following symmetric matrix [k₁(x₁,x₁)]_{1≦1,j≦1} is positive definite [symbol] for every finite selection of points x₁, . . . , xᵢ εX₀

Now, for simplicity let us consider a finite subset of measurements space Z=((x₁,y₁), . . . , (xₘ,yₘ))εD⊂X₀×{±1}. It is convenient to introduce special notation for the symmetric matrix [Kᵢⱼ⁽¹⁾]=[k₁(x₁,xⱼ)]_{1≦1,j≦m}, so called the kernel matrix, representing the kernel k₁ on the data of interest. The kernel matrix determines the feature mapping Φ₁|₍ₓ_{₁}_{, . . . , x}_{ₘ}₎ on the data in the following sense.
If kernel matrix [Kᵢⱼ⁽¹⁾] has rank n, than there exists a feature mapping Φ:X₀→Rⁿ such that [Kᵢⱼ⁽¹⁾] is its kernel matrix;
If Φ₂:X₀→X₂ is another feature mapping having [Kᵢⱼ⁽¹⁾] as its kernel matrix, then there exists a linear transformation ψ:X₁→X₂ which is an isometry of the linear expansions span {Φ₁(x₁), . . . , Φ₁(xₘ)f⊂X₁ and span {Φ₂(x₁), . . . , Φ₂(xₘ)}⊂X₂ of our data in the first and in the second feature space, respectively.

These two properties allow to concentrate on kernel, although conceptually, we investigate the properties of various feature representations.

The examples of popular practical kernels include the linear kernel kₗᵢₙ(x,x′)=(<x|x′>, the polynomial kernels k_{d}(x,x′)=(<x|x′>+1)^{d} of an integer degree d=2,3, . . . . and radial basis kernel (RBF-kernel), k(x,x′)=exp(−∥x−x′∥²/σ²), where the parameter σ≠0.

Although the invention has been described with reference to particular examples it should be appreciated that it may be applied in many other situations and in more complex ways. For instance, although we have described binary labels, Y={±1}, the more general case of multi-category classification can be reduced to a series of binary classification tasks, thus our considerations extend to that situation as well. However, the case of regression another practically important category of machine learning tasks, which involves non-discrete labels, is beyond the scope of this paper.

### Examples of Anti-Learning

In this section we present examples of anti-learning data.

Elevated XOR

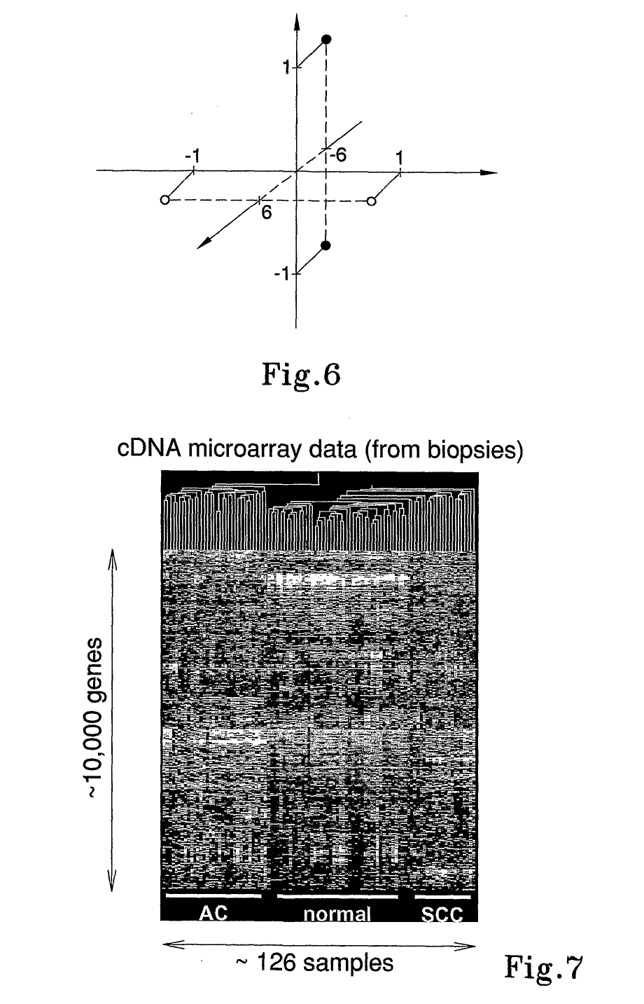

Elevated XOR a perfect anti-learnable data set in 3-dimensions which encapsulates the main features of anti-learning phenomenon, see FIG. 6. The z-values are ±ε. The linear kernel satisfies the CS-condition with r²=1+ε², c₀=−ε²r⁻² and c₋₁=c₊₁=(−1+ε²)r⁻². Hence the perfect anti-learning condition holds if ε>0.5. It can be checked directly, that any linear classifier such as perception or maximal margin classifier, trained on a proper subset misclassify all the off-training points of the domain. This can be especially easily visualized for 0<ε<<1.

### Molecular Biology Examples

Response to Chemotherapy for the Oesophogeal Cancer

This is a natural data set, composed of microarray profiles of esophageal cancer tissue. The data has been collected for the purpose of developing a molecular test for prediction of patient response to chemotherapy at Peter MacCallum Cancer Centre in Melbourne [Duong at al., 2004]. Currently there is no test for such a prediction, and resolution of this issue is of critical importance for oesophogeal cancer treatment. Each biopsy sample in the collection has been profiled for expression of 10,500 genes, see FIG. 7. Here gene expressions have been presented in a form of so called heat-map. The data has been clustered, and clustering has correctly identified three groups of samples: the adeno-carcinomas (AC), squamaous-cell-carcinomas (SCC), two major histological sub-types of this disease, and the “normal” non-tumour samples collected from each patient for a control purpose. Each patient in the experiment has been exposed to the same regime of chemo-radio-therapy and the corresponding sample has been labeled +1 or −1, accordingly to patient's response to the treatment.

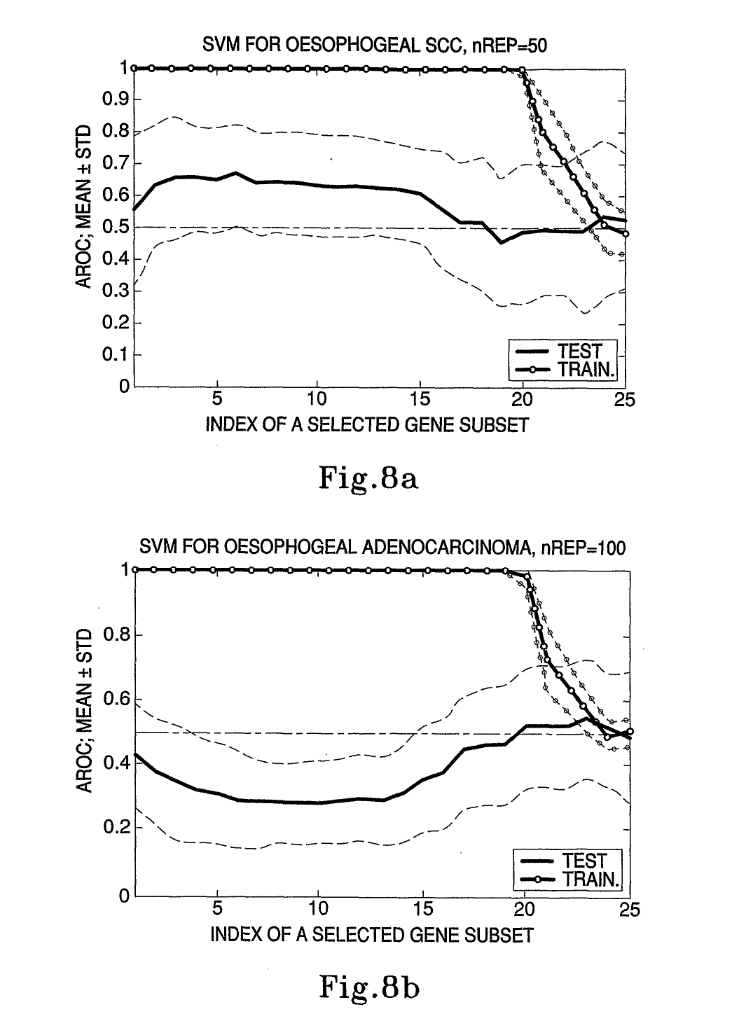

The labels has been used in classification experiments reported in FIG. 8(a) where we observe that the SCC data is learnable. In FIG. 8(b) we learn that Adeno-carcinoma is anti-learnable. In experiments data was randomly split into training (66%) and independent test (33%). The plots show averages of 50 and 100, repeats of such an experiment, respectively; the broken line shown mean±standard deviation. Observe clear learning for SCC samples and anti learning for adeno-carcinoma. This persists with a selection of features: in the experiments we have used 25 different subsets of genes selected using a univariate technique, the signal-to-noise ratio. The result is cross validation of prediction of the response to CRT treatment for esophageal cancer data.

Modeling Aryl Hydrocarbon Pathway in Yeast

This data consists of the combined training and test data sets used for task 2 of KDD Cup 2002 [Craven, 2002; Kowalczyk Raskutti, 2002]. The data set is based on experiments at McArdle Laboratory for Cancer Research, University of Wisconsin aimed at identification of yeast genes that, when knocked out cause a significant change in the level of activity of the Aryl Hydrocarbon Receptor (AHR) signalling pathway. Each of the 4507 instances in the data set is represented by a sparse vector of 18330 feawtres. Following the KDD Cup '02 setup terminology we experiment here with the either-task, discrimination 127 instances of pooled “change” and “control” class (labeled yᵢ=+1) and the rest, i.e. “nc” (4380 labeled yᵢ=−1). This data is heavily biased, with the proportions between the positive and negative lables, m₊:m.≈3%:97%. Hence we have implemented re-balancing via class dependent regularisation constants in the SVM training:

$${C}_{y} = \frac{1 + yB}{2 {m}_{y}} C \geq 0 ,$$

for y±1 and C>0. For instance, B=0 facilitates the case of “balanced proportions”, C₊₁:C₋₁=m₋₁:m₊₁, while B=+1 or B=−1 facilitates single class leaning, from the “positive” (+1SVM) or “negative” (−1SVM) class examples only, respectively.

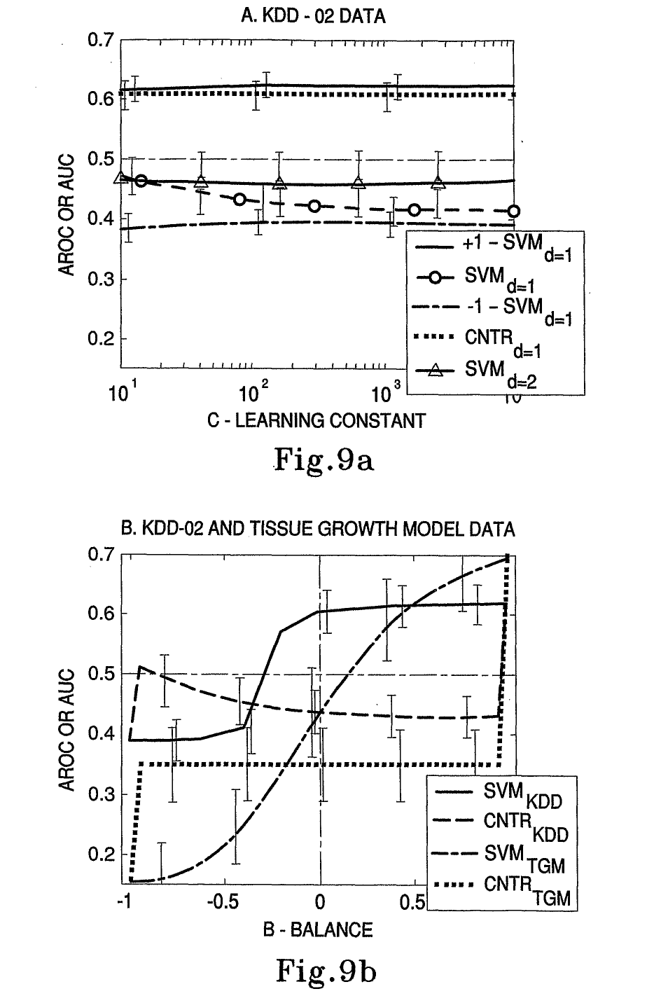

FIG. 9(a).A shows that +1SVM , the single class SVM trained on the minority class examples only, is learning, while the most common two class SVM ( B=0) classifiers and die single class (majority class) SVM, −1SVM, are anti-learning.

In FIG. 9(b) we observe a characteristic switch from anti-learning to learning in concordance with the balance parameter B raising from −1 to 1. Tis is shown for the real life KDD02 data and also for the synthetic Tissue Growth Model (TGM) data, described in the following section, for SVM and for the simple centric Cntr_{B} classifier.

The curves show averages of 30 trials. In experiments we used one and two class SVM and simple centroid classifier. All plots but one are for the linear kernel (subscript d=1). The curve SVM_{d=2} is for the second order polynomial kernel of degree 2; plots for other degrees, d=3,4 were very close to this one (data not shown).

Tissue Growth Model

This a synthetic data set, an abstract model of un-controlled tissue growth (like cancer) designed to demonstrate two things:
That microarray expression arrays can generate anti-learning data;
That there exist synthetic datasets with properties resembling those of the Aryl Hydrocarbon Receptor pathway discussed above.

The issue Growth Model is inspired by the existence of a real-life antilearning microarray data set, and we now present a ‘microarray scenario’ which provably generates antilearning data. We monitor tissue samples from an organ composed of l cell lines for detection of events where with time t the densities of cell lines depart from an equilibrium d₀ according to the law d(t)=(d₁(t))=d₀+(t−tₒ)νεR′. Here t₀ is unknown time, the start of the disease, ν=(ν₁)εR¹ is a disease progression speed vector. (We assume Σ₁d₁(t)=Σ₁d_{0,1}=1, hence Σ₁ν₁=0.)

We need to disc ate between two growth patterns, CLASS₋₁ and CLASS₊₁, defined as follows. The cell lines are split into three families, A, B and C, of l_{A}, l_{B} and l_{C} cell lines, respectively. CLASS₋₁ consists of abnormal growths in a single cell line of type A, say j_{A} εA cell line, resulting in the speed vector v_{jA}=(ν_{ijA}) with coordinates ν_{ijA}˜l−1 for i=jA and ν_{ijA}˜−1, otherwise. The CLASS₊ᵢ growths have one cell line of type B, say j_{B} εB, strongly changing which triggers a uniform decline in all cell lines of type C. This results in the speed vector v_{jB} with the coordinates ν_{ijB}˜b(l−1) for i=j_{B}, ν_{ijB}˜l−1, for iεC, and ν_{ijB}˜(l_{C}bl)/(l−l_{C}), otherwise, where bεR. We assume that our sample collection consists of all n=l_{A}+l_{B} possible such growth patterns.

The densities of cell lines are monitored indirectly, via a differential hybridization to a cDNA microarray chip which measures differences between pooled gene activity of cells of the diseased sample and the ‘healthy’ reference tissue, giving n labeled data points

$${x}_{j} = \frac{( t - {t}_{0} M {ν}_{j}}{‖ ( t - {t}_{n} ) M {ν}_{j} ‖} = \frac{M {ν}_{j}}{‖ M {ν}_{j} ‖} ∈ {R}^{{n}_{g}} \& {y}_{j} = - 1 if 1 \leq j \leq {I}_{A} , else {y}_{j} = 1$$

Here M is an n_{E}×l mixing matrix, n_{g}>>l is the number of monitored genes, and each column on M is interpreted as a genomic signature of a particular cell line, the difference between its transcription and the average of the reference tissue.

Mimicking High-Dimensional Distribution

This an example where anti-learning data arise naturally, in case of high dimensional approximations. This example can be also solved analytically, giving independent evidence for existence of the anti-learning phenomenon. On the basis of this example one can hypothesize that the immune system of a multi-cellular organism has a potential to force a pathogen to develop an anti-learning signature.

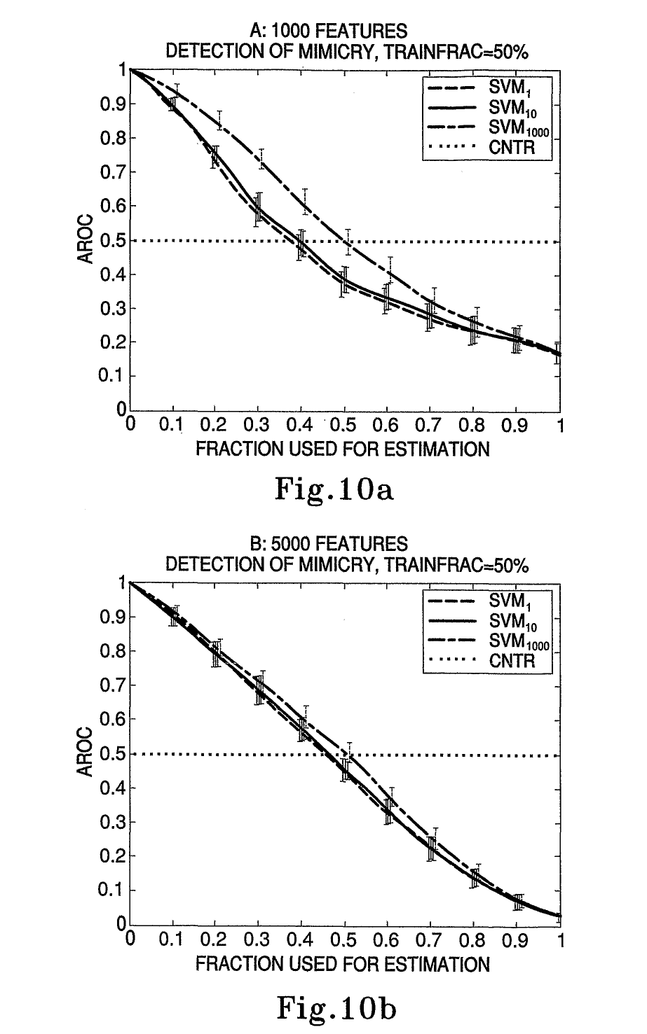

The experimental results demonstrating anti-learning in mimicry problem are shown in FIGS. 10(a) and (b). These results show discrimination between background and imposter distributions. Curves plot the area under ROC curve (AROC) for the independent test as a function of a fraction of the background class samples used for the estimation of the mean and std of the distribution. We plot means of 50 independent trials, for SVM filters trained on 50% of the data with regularization constants, as indicated in the subscript, and for the Centroid classifier (Cntr We have used n=1000 and n=5000 dimensional feature space respectively, and 100 samples in the background class and another 100 samples in the imposter class. In the background distribution a feature xᵢ has been drawn independently from a normal N(μᵢ,σᵢ) where μᵢ and σᵢ were chosen independently from the uniform distributions on [−5,+5] and [0.5,1], respectively, i=1, . . . , n.

Learning-Features Removal

These two examples demonstrate that anti-learning can be also observed in public domain microarray data. These examples also show that real life data are a mixture of “learning” and “anti-learning” features which compete with each other. Removal of anti-learning feature enhances performance of learning predictors. And conversely, removal of learning-features increases anti-learning performance.

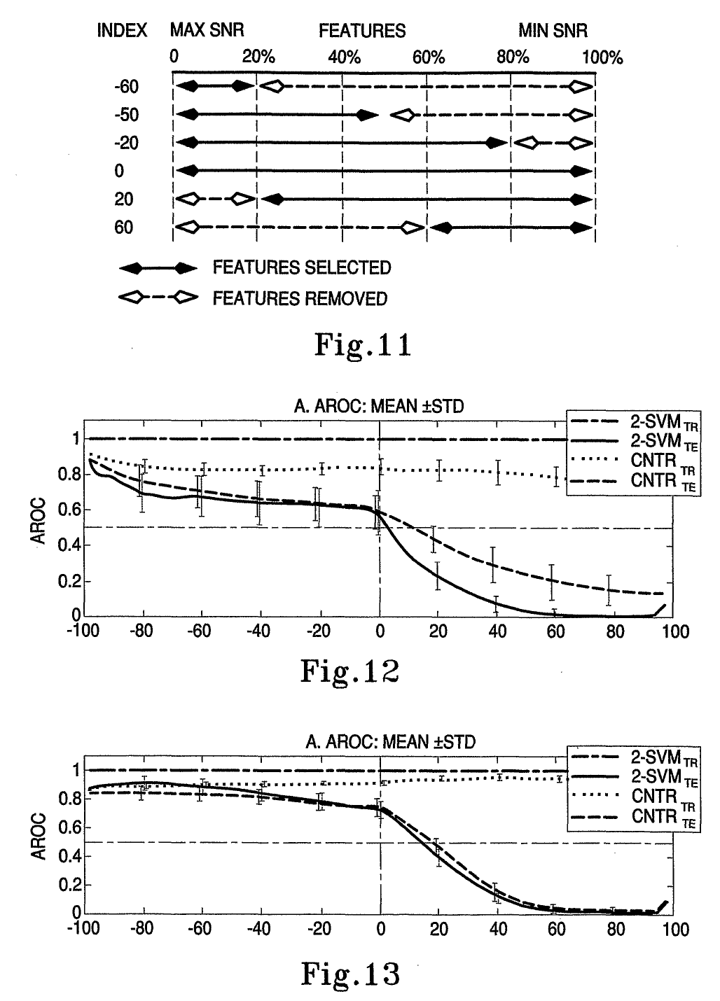

FIG. 11 is the tail/head index orders for different subsets of the features. The diagram shows the subset of features chosen for various values of the index.

Meduloblastoma Survival

We have used microarray gene expression data, originally studied in [Pomeroy et˜al., 2002] and now available from Nature's web site. In our experiment we have used data set C only (60 samples containing data for 39 meduloblastoma, a brain cancer, survivors and 21 treatment failures). We have used 4459 features (genes) filtered from the supplied data as described in Supplementary Information to the above publication.

The results are shown in FIG. 12 for 2 class SVM and the centroid algorithm using biased feature selection. Biased feature selection was used in [Pomeroy et˜al., 2002] as well. The plots show an average of 50 independent trails (traininig:test split=66% 34%). We observe the removal of most correlated features (according to the signal-to-noise ratio) cause predictors to become strongly anti-learning. The removal of features was performed according to the scheme outlined in the FIG. 11.

Prognosis of Outcome of Breast Cancer from Microarray Data

Here we use microarray gene expression data) originally studied in [van't Veer et˜al., 2002] and now available from Nature's web site. In our exponent we have used data for prognosis of breast cancer patient. This set of 97 samples contains 51 patient with poor prognosis (marked “<5YS” in the Sample Annotation_BR_{—}1.txt file supplied with the data) and 46 patients with good prognosis (marked “>5YS”). We have used all available 24481 features (genes) without any preprocessing (see the cited publication for details and information on availability of the data). The results are shown in FIG. 13 for 2 class SVM and the centroid algorithm using biased feature selection. Biased feature selection was used in [vantVeer 2002].

FIG. 13 shows the results of prognosis of breast cancer outcome experiments. This experiment is analogous to the Meduloblastoma experiment in FIG. 12. The training and test set performance for a cross validation experiments. Plots show an average of 50 independent trails (training:test split=66%:34%). We observe the removal of most correlated features (according to the signal-to-noise ratio) cause predictors to become strongly ant-learning. The removal of features was performed according to the scheme outlined in the FIG. 11.

Hadamard Matrices

Hadamard Matrices contain rows of mutually orthogonal entries ±1 with recursion

$${H}_{2 n} = [ \begin{matrix}{H}_{n} & {H}_{n} \\ {H}_{n} & - {H}_{n}\end{matrix} ] where {H}_{1} = [ 1 ] hence {H}_{4} = [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$$

Taking an arbitrary row i≠1 of Hₙ as set of labels Y, and using the columns of the remaining matrix as data X, we obtain data Hadₙ₋₁=(X,Y)⊂Rⁿ⁻¹x{±1}. For instance, for n=4 and i=3 and the linear kernel on R³ we obtain

$$Y = \{ 1 , 1 , - 1 , - 1 \} , X = \{ [ \begin{matrix}1 \\ 1 \\ 1\end{matrix} ] , [ \begin{matrix}1 \\ - 1 \\ - 1\end{matrix} ] , [ \begin{matrix}1 \\ 1 \\ - 1\end{matrix} ] , [ \begin{matrix}1 \\ - 1 \\ 1\end{matrix} ] \} , K = [ \begin{matrix}3 & - 1 & 1 & 1 \\ - 1 & 3 & 1 & 1 \\ 1 & 1 & 3 & - 1 \\ 1 & 1 & - 1 & 3\end{matrix} ]$$

More generally, since the columns of the Hadamard matrix are orthogonal we obtain y₁y₁<xᵢ,xⱼ<=nδᵢⱼy₁yⱼ−1<0 for i≠j. This means that kernel matrix K obtained from Hadₙ₋₁ satisfies the conditions of perfect antilearning. Note that also K+c satisfies the same conditions for any cεR.

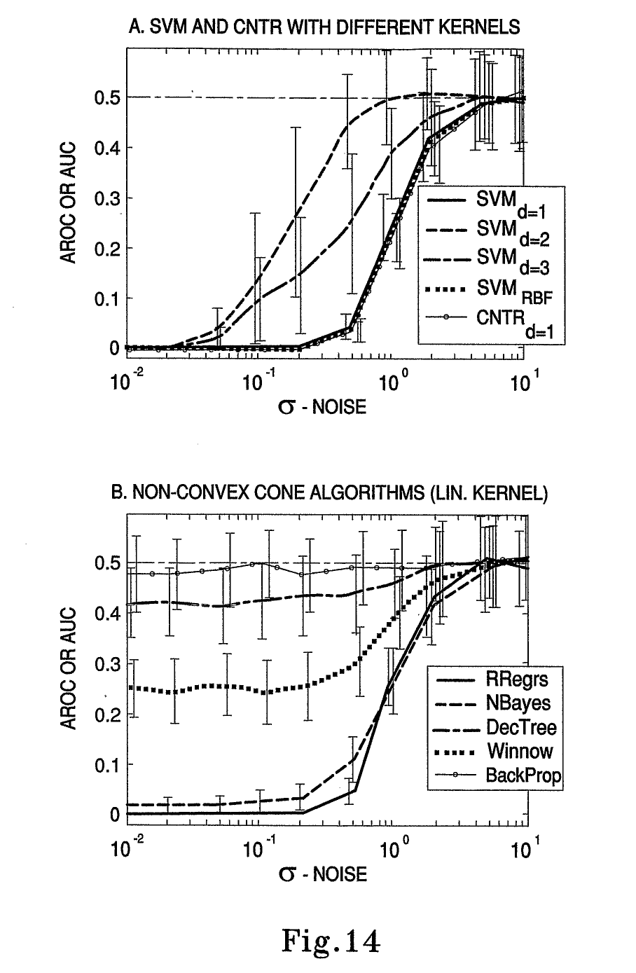

Results of experiments for a raft of different classifiers are given in FIG. 14. We compared Ridge Regression, Naive Bayes, Decision Trees (Matlab toolbox), Winnow, Neural Networks (Matlab toolbox with default settings), the Centroid Classifier, and SVMs with polynomial kernels of degree 1, 2, and 3. All classifiers performed better then 0.95 in terms of AROC[ƒ,Z] on the training set regardless of the amount of noise added to the data, the exception being Winnow (AROC[ƒ,Z]≧0.8) and the Neural Network (AROC[ƒ,Z]=0.5±0.03). We averaged the results-over 100 trials with the standard deviation reported by the error bars. ⅔ of the data Had₁₂₇ was used for training and the remainder for testing.

Both the Neural Network and Decision Trees performed close to random guessing. Winnow shows weak antilearning tendencies, all other classifiers (Naive Bayes, SVM, Centroid, and Ridge Regression) are strongly antilearning if the noise is not too high. The findings corroborate Theorem 1.

FIG. 14 is an Area under ROC curve for an independent test on random 34% of Hadamard data, Had₁₂₇, with additive normal noise N(0,σ) and random rotation.

### INDUSTRIAL APPLICATION

The invention is applicable in many areas, including:

Authentication from multi-dimensional data.

Fraud detection.

Document authorship verification.

Authentication from technological imperfections, such as random imperfections in manufacturing, natural or embedded.

Identification of a printer via multiple natural imperfections.

Money forgery detection.

Watermarking by embedding of slight noise in a document, especially images.

Medical diagnosis, for instance the prediction of response to chemotherapy for esophageal and other cancers and molecular diseases.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### REFERENCES

[Bamber, 1975]; D.˜Bamber. The area above the ordinal dominance graph and the area below the receiver operating characteristic graph. Journal of Mathematical Psychology, 12, 387-415, 1975.

[Craven, 2002], M. Craven, The Genomics of a Signaling Pathway: A {KDD} Cup Challenge Task, SIGKDD Explorations, 2002, 4(2).

[Duong at al., 2004]; Cuong Duong, Adam Kowalczyk, Robert Thomas, Rodney Hicks, Marianne Ciavarella, Robert Chen, Garvesh Raskutti, William Murray, Anne Thompson and Wayne Phillips, Predicting response to chemoradiotherapy in patients with oesophageal cancer, Global Challenges in Upper Gastrointestinal Cancer, Couran Cove, 2004.

[Kowalczyk Raskutti, 2002], Kowalczyk, A. and Raskutti, B., One Class SVM for Yeast Regulation Prediction, SIGKDD Explorations, \bf 4(2), 2002.

[Raskutti Kowalczyk 2004], Raskutti, B. and Kowalczyk, A., Extreme re-balancing for SVMs: a case study, SIGKDD Explorations, 6 (1), 60-69, 2004.

[Pomeroy et˜al., 2002], Pomeroy, S., Tamayo, P., Gaasenbeek, M., Sturla, L., Angelo, M., McLaughlin, M., Kim, J., Goumnerova, L., Black, P., Lau, C., Allen, J., Zagzag, D., Olson, J., Curran, T., Wetmore, C., Biegel, J., Poggio, T., Mukherjee, S., Rifkin, R., Califano, A., Stolovitzky, G., Louis, D., Mesirov, J., Lander, E., \& Golub, T. (2002). Prediction of central nervous system embryonal tumour outcome based on gene expression. Nature, 415, 436-442.

[van't Veer et˜al., 2002]: van't Veer, L.˜J., Dai, H., van˜de Vijver, M., He, Y., Hart, A., Mao, M., Peterse, H., van˜der Kooy, K., Marton, M., Witteveen, A., Schreiber, G., Kerkhoven, R, Roberts, C., Linsley, P., Bernards, R., & Friend, S. Gene expression profiling predicts clinical outcome of breast cancer. Nature, 415}, 530-536.

1. Apparatus for data mining unlearnable data sets, comprising:
a learning device trained using a supervised learning algorithm to predict labels for each item of a training sample and, to predict labels for other data from the data set; and
a reverser to apply negative weighting to labels predicted for the other data from the data set using the learning device if the other data is anti-learnable.

2. Apparatus according to claim 1, further comprising:
a further learning device trained using a further supervised learning algorithm to predict labels for each item of a further training sample and, to predict labels for the other data from the data set; and,
a reverser to apply negative weighting to labels predicted for the other data from the data set using at least one learning device if the other data is anti-learnable.

3. Apparatus according to claim 2, wherein the training samples are distinct from each other.

4. Apparatus according to claim 1, wherein the apparatus are embodied in a neural network.

5. Apparatus according to claim 1, wherein at least one of the learning devices uses the k-nearest neighbor method.

6. Apparatus according to claim 1, wherein at least one of the learning devices is a support vector machine.

7. Apparatus according to claim 1, wherein the reverser operates automatically.

8. Apparatus according to claim 1, wherein the reverser is implemented as a direct majority voting method.

9. Apparatus according to claim 1, wherein the reverser is developed from the data using a supervised machine learning technique.

10. A method for extracting information from unlearnable data sets, the method comprising the steps of.
creating a finite training sample from the data set;
training a learning device using a supervised learning algorithm to predict labels for each item of the training sample;
processing other data from the data set to predict labels and determining whether the other data is learnable or anti-learnable; and,
applying negative weighting to the predicted labels if the other data is anti-learnable.

11. A method according to claim 10, comprising the further steps of:
training a further learning device using a further supervised learning algorithm to predict labels for each item of a further training sample;
processing the other data from the data set to predict labels and determining whether the predicted labels of the first and former learning devices are learnable or anti-learnable; and,
applying negative weighting to the predicted labels of a learning device if the data is anti-learnable.

12. A method according to claim 10, comprising the additional step of training a reverser to apply the negative weighting automatically.

13. A method according to claim 10, including the further step of transforming anti-learn able data into learnable data for conventional processing.

14. A method according to claim 13, wherein the transformation employs a kernel transformation.

15. A method according to claim 14, wherein the transformation increases within-class similarities and decreases between class similarities.

16. A method according to claim 10, comprising the additional step of using a learning device to further process the weighted data.

17. A method according to claim 10, comprising the additional step of reducing the size of the training samples.

18. A method according to claim 10, comprising the additional step of selecting less informative training data.

19. A method according to claim 17, wherein Mercer kernels are used.

20. A method according to claim 10, wherein the method is embodied in software.

21. A method according to claim 18, wherein Mercer Kernels are used.
